(19) United States
(12) Patent Application Publication
(10) Pub. No.: US 2025/0360861 A1
(43) Pub. Date: Nov. 27, 2025

(54) STORABLE TABLE ASSEMBLIES FOR VEHICLES

(71) Applicant: MORRYDE INTERNATIONAL, INC., Elkhart, IN (US)

(72) Inventors: Ben Kauffman, Goshen, IN (US); Anthony J. Granzotto, Constantine, MI (US)

(21) Appl. No.: 19/214,331

(22) Filed: May 21, 2025

Related U.S. Application Data
(60) Provisional application No. 63/651,470, filed on May 24, 2024.

(51) Int. Cl. B60P 3/36; B60N 3/00; B62D 65/02

(52) U.S. Cl. CPC B60P 3/36; B60N 3/001; B62D 65/02

(57) ABSTRACT

Table assemblies for vehicles include a mount, a table, and a sliding mechanism coupled between the table and the mount, such that the table is movable between a storage position within an interior of the mount and a use position through an opening in an exterior of the vehicle.

### CROSS-REFERENCE TO RELATED APPLICATION

This application claims the priority benefit of U.S. Provisional Application No. 63/651,470, filed May 24, 2024, which is hereby incorporated herein for all purposes.

### FIELD OF THE DISCLOSURE

The present disclosure generally relates to storable fixtures for recreational vehicles.

### SUMMARY

In accordance with a first example, a table assembly for a vehicle is described that includes a mount, the mount being part of base structure of the vehicle or configured to be coupled to the vehicle within or adjacent to the base structure of the vehicle, a table having an upper surface, and a sliding mechanism coupled between the table and the mount, such that the table is movable between a storage position within an interior of the mount and a use position through an opening in an exterior of the vehicle.

In some examples, the mount includes side walls and a top wall extending between the side walls, the sliding mechanism coupled to the side walls. In further examples, the sliding mechanism includes at least one of: opposing rails having upper and lower walls defining a track therebetween and sliders coupled to lateral edges of the table and received between the upper and lower walls to slide within the track; a plurality of slide members nested together with bearings disposed therebetween; or a bracket defining an elongate track opening and one or more posts coupled to lateral edges of the table and extending through the elongate track opening to slide therealong.

In some examples, the table assembly includes one or more supports to hold the table in a horizontal orientation in the use position. In further examples, the one or more supports are one or more of: the sliding mechanism; one or more tethers (e.g., rigid or flexible tethers) coupled to a front end portion of the table and configured to releasably couple to one of the mount or the vehicle; or brackets pivotably coupled to the table, the brackets configured to be pivoted to extend transverse to the table and releasably couple to one of the mount or the vehicle.

In some examples, the table assembly includes one or more stops configured to selectively restrict movement of the table from the use position to the storage position. In further examples, the one or more stops are one or more of: rigid tethers coupled to the table and configured to releasably couple to one of the mount or the vehicle; or brackets pivotably coupled to the table, the brackets configured to be pivoted to extend transverse to the table and releasably couple to one of the mount or the vehicle.

In some examples, the table assembly includes a table extension pivotably coupled to the table, the table extension pivotable between a storage position extending across an upper surface of the table and a use position extending forwardly from the table, and/or a door pivotably coupled to the mount to selectively cover the opening in the exterior of the vehicle.

In accordance with second examples, a vehicle can include any of the above example table assemblies. In these examples, the base structure of the vehicle can include a frame and a floor disposed above the frame, wherein the mount is installed within a recess defined in the floor of the vehicle between an upper surface of the floor and the frame. In these examples, the base structure of the vehicle can include a frame, a floor disposed above the frame, and a bottom skirt portion of the exterior extending downwardly relative to the floor, wherein the mount is installed within a recess defined between the frame and the bottom skirt portion.

In accordance with a third example, a method is described that includes coupling a sliding mechanism of a table assembly to a mount within a recess defined in base structure of a vehicle, the table assembly including a table coupled to the sliding mechanism to be movable relative to the vehicle.

In some examples, the method includes cutting an opening in an exterior of the vehicle and installing the mount within the recess. In further examples, installing the mount within the recess includes one of: removing material of a floor of the vehicle to create the recess or installing the mount beneath the floor of the vehicle aligned with the opening.

### BRIEF DESCRIPTION OF THE DRAWINGS

FIG. 1 is a diagrammatic side view of an example vehicle in accordance with the teachings of the present disclosure.

FIG. 2 is a bottom perspective view of a first example table assembly showing a table in a storage position in accordance with the teachings of the present disclosure.

FIG. 3 is a top sectional perspective view of the table assembly of FIG. 2 showing the table in the use position.

FIG. 4 is a bottom sectional perspective view of the table assembly of FIG. 2 showing the table in the use position.

FIG. 5 is a front perspective view of the table assembly of FIG. 2 showing details of a sliding mechanism.

FIG. 6 is a bottom perspective view of a second example table assembly showing a table in a storage position in accordance with the teachings of the present disclosure.

FIG. 7 is a top sectional perspective view of the table assembly of FIG. 6 showing the table in the use position.

FIG. 8 is a bottom sectional perspective view of the table assembly of FIG. 6 showing the table in the use position.

FIG. 9 is a front perspective view of the table assembly of FIG. 6 showing details of a sliding mechanism.

FIG. 10 is a bottom perspective view of a third example table assembly showing a table in a storage position in accordance with the teachings of the present disclosure.

FIG. 11 is a top sectional perspective view of the table assembly of FIG. 10.

FIG. 12 is a bottom sectional perspective view of the table assembly of FIG. 10 showing the table in the use position.

FIG. 13 is a top sectional perspective view of the table assembly of FIG. 10 showing the table in the use position.

FIG. 14 is a front perspective view of the table assembly of FIG. 10 showing details of a sliding mechanism.

FIG. 15 is a top perspective view of an example table for a table assembly showing a hinged extension position in a storage position.

FIG. 16 is a bottom perspective view of an example table for a table assembly showing a sliding extension portion in a use position.

### DETAILED DESCRIPTION

Table assemblies are provided that can be stored within a space or recess below a floor upper surface in a vehicle. The table assemblies are accessible through an exterior opening in the vehicle and are configured to be pulled out from the space or recess for use. The table assemblies can include a slider mechanism to guide the table from a storage to a use position. The table can remain attached to the vehicle in the use position, such as via the slider mechanism and/or can be detachable from the vehicle for use.

A vehicle 10 as described herein can be a “recreational vehicle” or “RV” which includes toy haulers, travel trailers, fifth wheels, goosenecks, motor homes, campers, and so forth. The vehicle 10 can also be a utility trailer or utility vehicle. The vehicle 10 can be a towable trailer or a motorized unit.

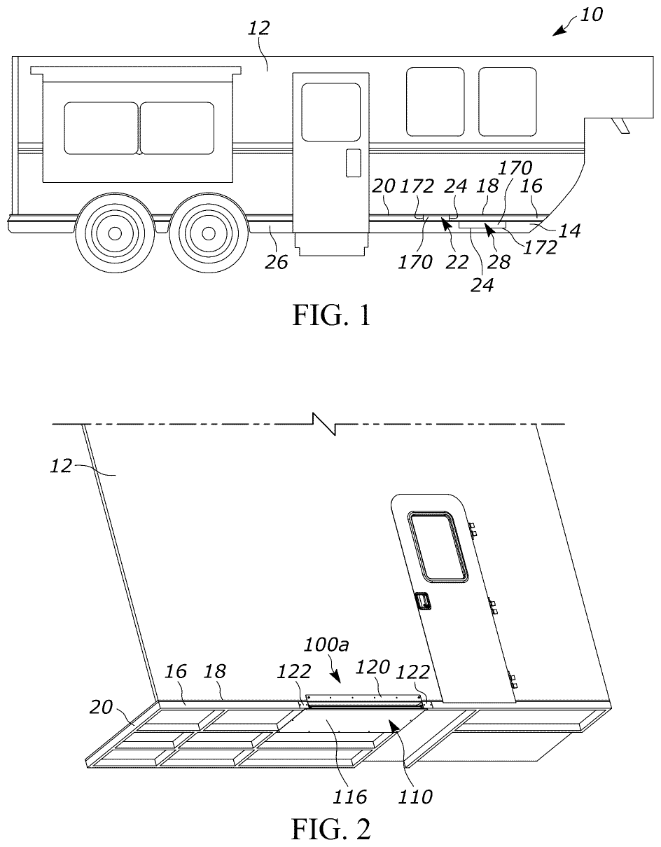

An example vehicle 10 is shown in FIG. 1 that has an exterior 12 formed at least partially from sheets or members made from a suitable material, e.g., metal and/or plastic. The vehicle 10 includes a base structure including a frame 14 and a floor 16 that is disposed above the frame 14. In some examples, the base structure also includes outriggers from the frame. As used herein, the floor 16 includes an upper surface 18, as well as the structure 20 extending between the upper surface 18 and the frame 14. The floor 16 can have any suitable configuration. For example, the structure 20 can include studs as shown in FIGS. 2, 6, and 8 in a grid pattern, one or more layers of base material, such as plywood or the like, an extrusion of a suitable material, such as aluminum, and so forth.

In these examples, table assemblies as described herein can be installed in a cavity or recess 22 defined or formed within the floor structure 20 between the frame 14 and the upper surface 18 of the floor 16 with an opening 24 exposed through the exterior 12 of the vehicle 10. The opening 24 and/or the recess 22 can be cut from or otherwise defined in previously assembled structure of the vehicle 10 in a retrofit manner. Alternatively, the opening 24 and/or recess 22 can be formed during initial assembly of the vehicle 10. It will be understood that the depth, width, and height of the recess 22 and opening 24 can be varied for any desired configuration or requirement.

In additional or alternative examples, the exterior 12 of the vehicle 10 can include a bottom skirt portion 26 that depends downwardly from a height of the floor 16 to hide the frame 14, among other uses. The skirt portion 26 is spaced from the frame 14 by a space or recess 28. In some examples, the table assemblies can be installed within this recess 28 with the table assemblies extending between the exterior 12 and the frame 14, and the opening 24 can be exposed through the skirt portion 26 of the exterior 12. Accordingly, although the below examples are discussed with reference to an installation within the floor 16 of the vehicle 10, the below examples apply equally to an installation beneath the floor 16 of the vehicle 10, which can include the table assemblies being secured to a bottom surface of the floor, to the frame 14, to outriggers from the frame 14, or combinations thereof. It will be understood that the depth, width, and height of the opening 24 and table assembly in these examples can be varied for any desired configuration or requirement.

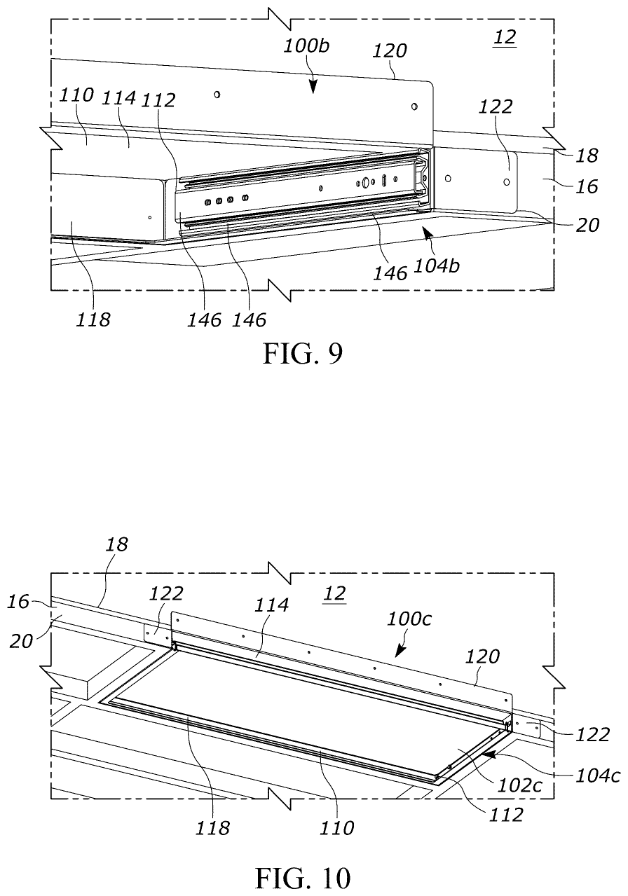

Example table assemblies 100a-100c are shown in FIGS. 2-14. The table assemblies 100a-100c each include a table 102a-102c movably coupled to the vehicle 10 via a sliding mechanism 104a-104c between a storage position within the recess 22, 28 and a use position extending outwardly from the vehicle 10 or to an extended position to be detached from the vehicle 10. The table assemblies 100a-100c include supports 106a-106c operable to support the table 102a-102c in a horizontal orientation when in the use position. In some instances, the table assemblies 100a-100c can also include stops 108a-108c that function to hold the table 102a-102c in the use position and restrict movement of the table 102a-102c back towards the storage position. The configurations and/or components for the table assemblies 100a-100c are exemplary and should be understood to be interchangeable between the examples described herein.

In some examples, the table assemblies 100a-100c include or are configured to be coupled to a mount 110. The mount 110 can be a separate component or components that are sized to fit within the recess 22, 28 and/or can be defined by base structure of the vehicle 10. The mount 110 has side walls 112 providing a mounting surface for the sliding mechanism 104a-104c, such that the table 102a-102c can be moved relative to the mount 110.

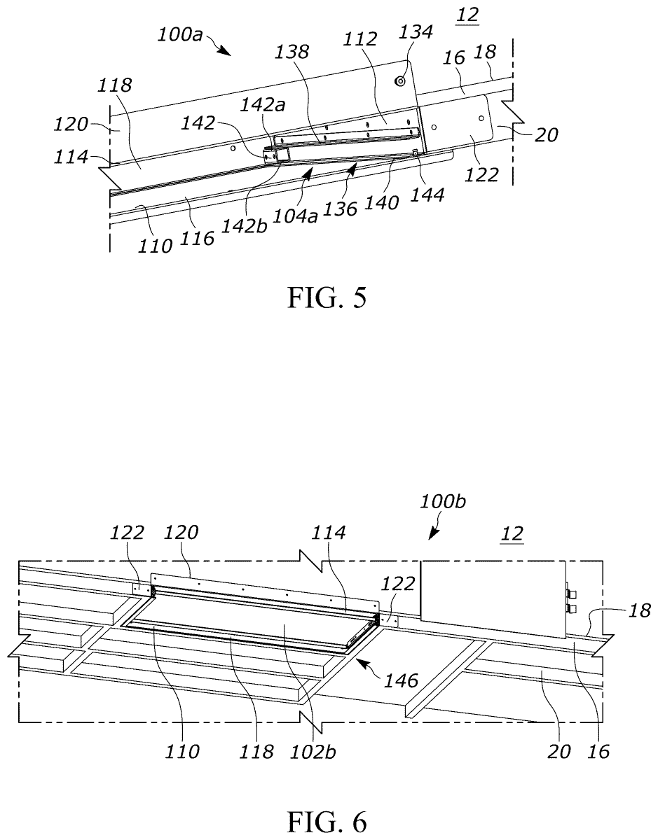

In further examples, the mount 110 includes a top wall 114 extending between the side walls 112 and, optionally as shown in FIGS. 2 and 4, the mount 110 also includes a bottom wall 116 extending between the side walls 112 opposite of and generally parallel with the top wall 114, such that the mount 110 has a box shape. The mount 110 can also include a back wall 118 opposite the opening 24. As shown in FIGS. 5, 9, and 14, the sliding mechanisms 104a-104c are at least partially coupled to the side walls 112 to allow the table 102a-102c to be shifted relative thereto. The walls 112, 114, 116, 118 of the mount 110 can be permanently secured together, such as by welding, extrusion, or the like, can be secured together with fasteners, and/or can be separately secured to the vehicle 10.

The mount 110 can also include associated strength reinforcement features. The strength reinforcement features can function to reinforce the floor 16 against buckling or bending in the area of the recess 22 and/or add rigidity to the mount 110. The strength reinforcement features can also be utilized to at least partially secure the mount 110 to the vehicle 10. In some examples, the strength reinforcement features include a top bracket 120 extending upwardly from the box top wall 114. The top bracket 120 can extend along the vehicle exterior 12 as shown or can extend along an interior surface of the wall. As shown, fasteners can be inserted through the top bracket 120 to secure to the exterior wall and floor 16 of the vehicle 10. The mount 110 can also include side brackets 122 extending laterally along the vehicle exterior 12 from the box side walls 112 to receive fasteners therethrough. The mount 110 could also include ribs (not shown) extending along the top wall 114 and/or struts (not shown) extending vertically along the side walls 112 and/or back wall 118 to reinforce the top wall 114.

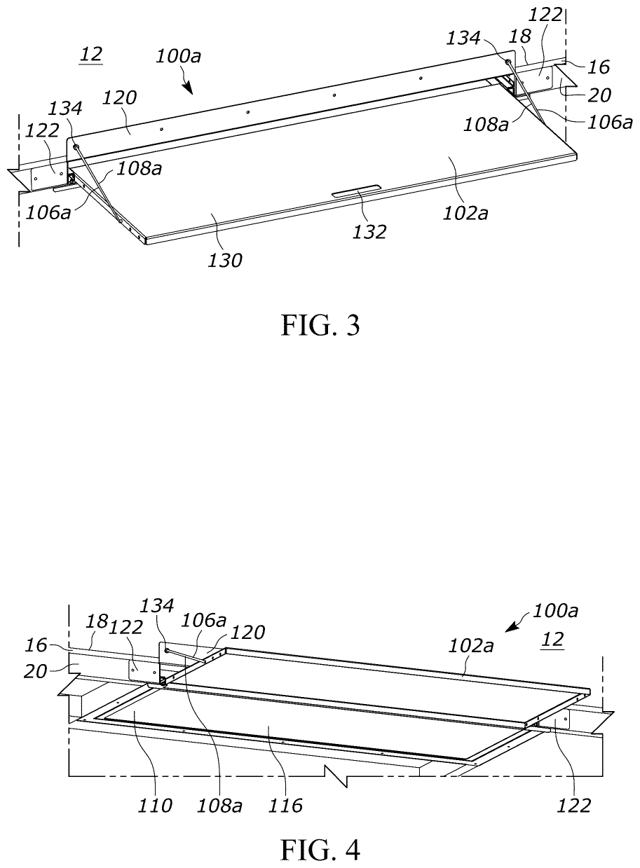

A first example table assembly 100a is shown in FIGS. 2-5. A frame for the vehicle 10 is omitted in the figures to better show the features of the assembly 100a. The table 102a is movable between a storage position shown in FIG. 2 and a use position shown in FIGS. 3 and 4. The table 102a has an upper surface 130 capable of supporting articles thereon. If desired, the table 102a can include a recess or opening 132 for a grip to pull the table 102a from the storage position.

In this example, the supports 106a include tethers, e.g., wires or rods, having a first end permanently or removably coupled to the table 102a, such as to a front end portion of the table 102a as shown, and an opposite end couplable to the mount 110 or vehicle 10. As shown, the end of the support 106a can be engaged onto a protrusion 134, such as a peg, hook, etc., projecting from the mount 110, as shown, or from the vehicle 10. The support 106a can be rigid or flexible. If rigid, the support 106a can also act at the stop 108a to prevent the table 102a from being inadvertently moved to the storage position. Additionally, although the protrusion 134 is shown above the recess 22, with a rigid support 106a, the protrusion 134 can be disposed below the recess 22 to support the table 102a from below.

The sliding mechanism 104a of this example is shown in more detail in FIG. 5. The sliding mechanism 104 includes opposing rails 136 coupled to the side walls 112 of the mount 110. Each rail 136 has upper and lower walls 138, 140 defining a track therebetween. The table 102a is sized to extend between the rails 136 so that lateral edges are disposed adjacent to the track. Sliders 142 are coupled to the lateral edges of the table 102a adjacent to a rear edge thereof. The sliders 142 are sized to extend substantially the entire distance between the upper and lower walls 138, 140 of the rail 136 to slide therebetween and, if desired, can have a length sufficient to at least partially support the table 102a in a horizontal orientation. Additionally, the slider 142 can have flat upper and lower surfaces 142a, 142b configured to provide a larger engagement with the upper and lower walls 138, 140. For example, the slider 142 can have a rectangular cross-section as shown. The slider 142 can be made from or include any suitable material. For example, the slider 142 can include a low-friction layer or be made from a low friction plastic to make sliding within the rail 136 easier. A pin or other protrusion 144 is disposed at an end of the rail 136 adjacent to the opening 24. The pin 144 projects into the track to stop movement of the slider 142 when the table 102a has been fully shifted to the use position. Of course, if full detachment of the table 102a is desired, the pin 144 can be omitted or be removable/depressible.

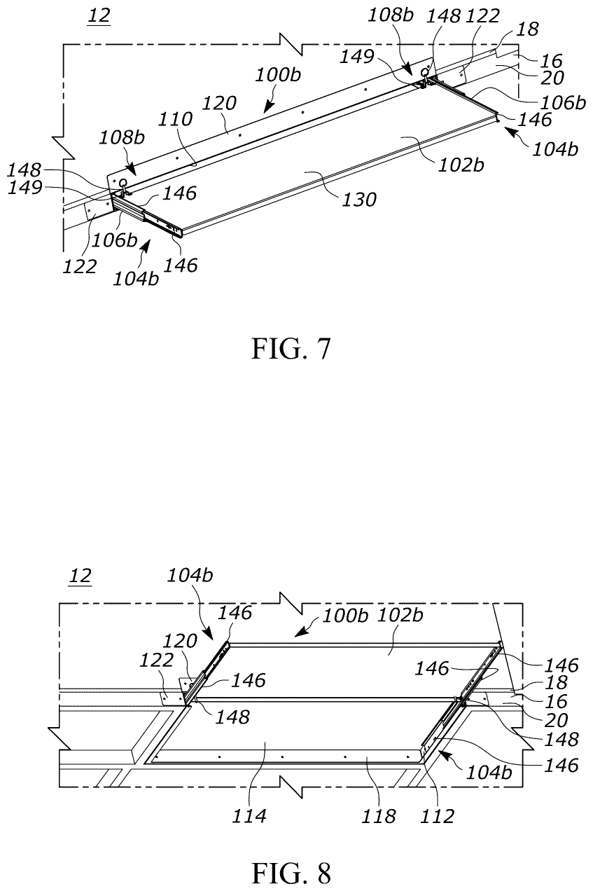

A second example table assembly 100b is shown in FIGS. 6-9. A frame for the vehicle 10 is omitted in the figures to better show the features of the assembly 100a. Additionally, although the assembly 100b is shown without the mount bottom wall 116, the bottom wall 116 can included with this example, if desired. The table 102b is movable between a storage position shown in FIG. 6 and a use position shown in FIGS. 7 and 8. The table 102b has an upper surface 130 capable of supporting articles thereon.

In this example, the sliding mechanism 104b is a slide assembly having interlocking and nesting slide members 146. Bearings (not shown) disposed between the slide members 146 allow the table 102b to be moved between the storage and use positions as the slide members 146 shift forwardly and backwardly relative to one another. The slide assembly can be configured with a strength and rigidity sufficient to support the table 102b in a horizontal orientation in the use position and, as such, can also provide the supports 106b. The slide assembly also has a predetermined extension length, which can be configured to correspond to the table 102b being in the use position.

As shown in FIG. 7, the table assembly 100b includes removable pins 148 configured to be removably coupled to the table 102b when the table 102b is in the use position to provide the stops 108b. When coupled to the table 102b, the pins 148 are sufficiently long to abut the exterior 12/mount 110 if the table 102b is shifted towards the use position. In some examples, the table assembly 100b includes brackets 149 having a raised center portion to provide a seat for the pins 148. The brackets 149 and table 102b have aligned openings to allow the pin 148 to extend therethrough. The pin 148 can include a radial protrusion or the like to abut structure and prevent further insertion so as to be aligned forwardly of the exterior 12/mount 110. To move the table 102b to the storage position, a user can pull the pins 148, which allows free movement of the table 102b. Alternatively, the table assembly 100b can include one or more integrated catches that engage the mount 110 or the vehicle 10 (e.g., an aperture or recess) when the table 102b is pulled out to the use position. For example, the catches can be biased by a spring or the like. The catches can include a release lever or can be otherwise pushed against the biasing force of the spring to allow the table 102b to be pushed back to the storage position.

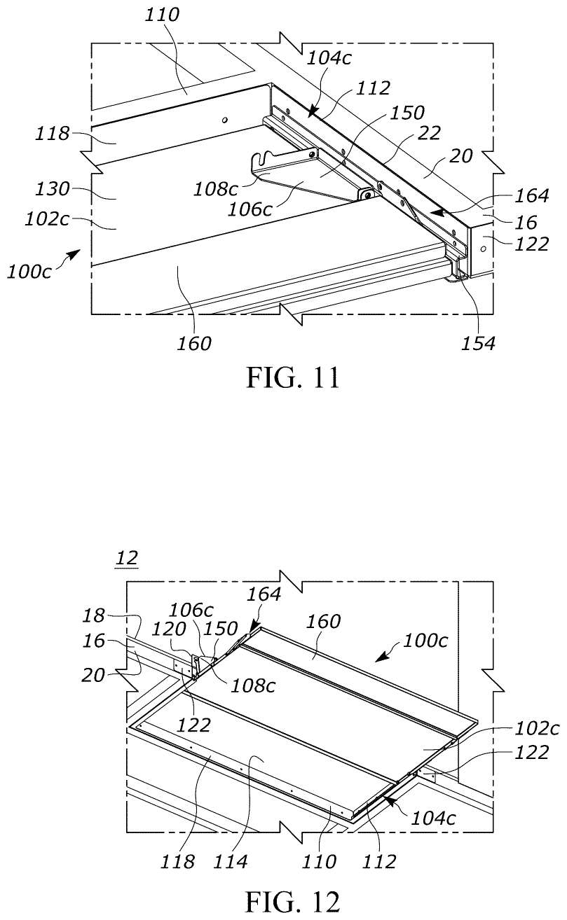

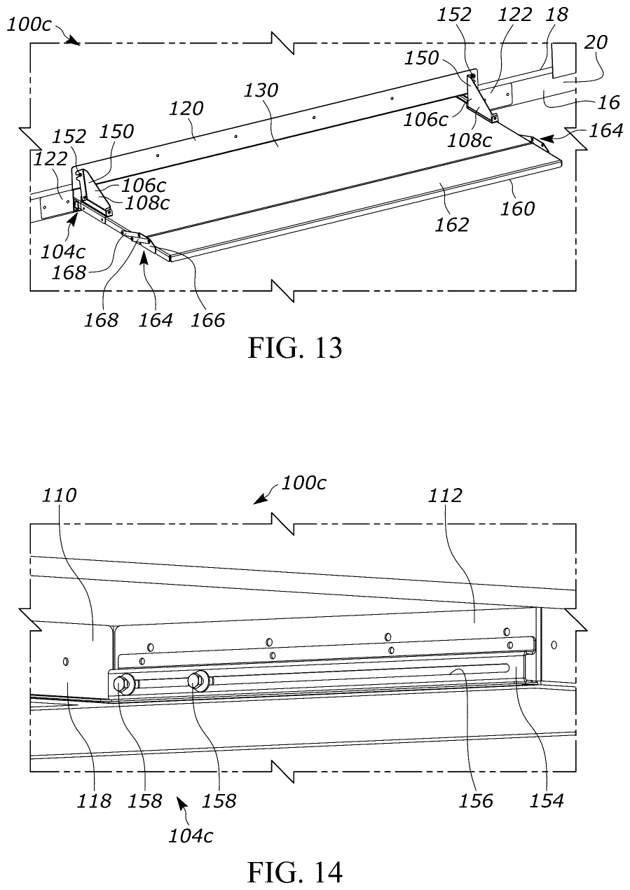

A third example table assembly 100c is shown in FIGS. 10-14. A frame for the vehicle 10 is omitted in the figures to better show the features of the assembly 100c. Additionally, although the assembly 100c is shown without the mount bottom wall 116, the bottom wall 116 can included with this example, if desired. The table 102c is movable between a storage position shown in FIGS. 10 and 11 and a use position shown in FIGS. 12 and 13. The table 102c has an upper surface 130 capable of supporting articles thereon.

In this example, the supports 106c include brackets 150 that are pivotably coupled to the table 102c. In the storage position, as shown in FIG. 13, the brackets 150 extend along the table 102c to fit within the recess 22. In the use position, a user pivots the brackets 150 away from the table 102c to extend generally transverse therefrom and engage a protrusion 152, such as a peg, hook, catch, etc., projecting from the mount 110, as shown, or from the vehicle 10. The engagement with the protrusion 152 releasably holds the bracket 150 in an upright orientation to thereby support the table 102c in a horizontal orientation when in the use position. As the bracket 150 is rigidly coupled between the table 102c and the mount 110/vehicle 10, the bracket 150 also acts as the stop 108c to prevent the table 102c from being inadvertently moved to the storage position. Additionally, although the brackets 150 are shown as coupled to be pivotable above the table 102c, the brackets 150 can be pivotable to a position below the table 102c to support the table 102c from below.

The sliding mechanism 104c of this example is shown in more detail in FIG. 14. The sliding mechanism 104c includes side brackets 154 defining an elongate track opening 156 therethrough that faces lateral edges of the table 102c. The side brackets 154 are coupled to the side walls 112 of the mount 110. Posts 158 extend laterally from the ends of the table 102c through the track opening 156 to slidingly couple the table 102c to the side brackets 154. Each side of the table 102c can include one or more of the posts 158. With two or more posts 158 on each side, the sliding mechanism 104c can support or help support the table 102c in a horizontal orientation. The length of the track opening 156 is configured, such that when a rearmost post 158 is adjacent to the inner end of the track opening 156, the table 102 is in the stored position and when a forwardmost post 158 is adjacent to an outer end of the track opening 156, the table 102c is in the use position. Of course, if full detachment of the table 102c is desired, the track opening 156 can include a slot or movable cover for selective passage of the posts 158.

The posts 158 can have any suitable form. For example, the posts 158 can be bolts with nuts and washers as shown to couple to the table 102c and side brackets 154. The posts 158 can include a slider member having a cross-sectional shape complementary to the interior of the side brackets 154. The posts 158 can include one or more bearings, rollers, or bushings to aid in sliding along the track opening 156.

As shown in FIGS. 11-13, a table extension 160 can be pivotably coupled to the table 102c. The table extension 160 is pivotable from a storage position extending along the upper surface 130 of the table to a use position disposed forwardly of the table 102c. As shown, an upper surface 162 of the table extension 160 can be substantially co-planar with the upper surface 130 of the table 102c. Hinges 164 extend between lateral edges of the table extension 160 and lateral edges of the table 102c to enable the table extension 160 to pivot between the storage and use position. The hinges 164 can have any suitable configuration. In the illustrated configuration, the hinges 164 include plates 166 for the table 102c and table extension 160, with two bars 168 having ends pivotably coupled to the plates 166. The bars 168 can be spaced so that they rest along another in the use position to provide additional support for holding the table extension 160 in a horizontal position. Additionally, the hinges 164 can be configured so that the inner edge of the table extension 160 when in the use position abuts the table 102c for added rigidity and to provide a substantially continuous work surface. Although shown with the table 102c of FIGS. 10-14, the earlier-described tables 102a and 102b can include similarly configured table extensions.

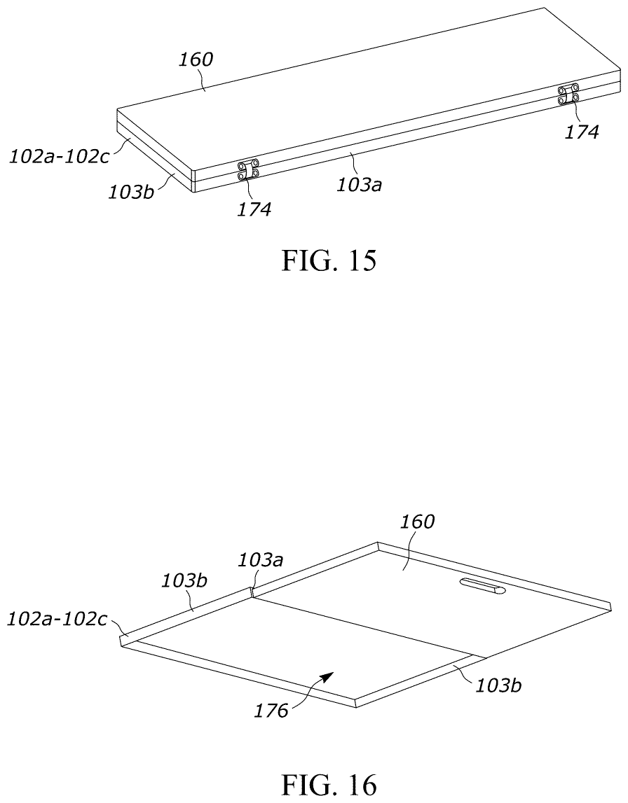

Other example connections for table extensions 160 are shown in FIGS. 15 and 16. The table extensions 160 of these examples are suitable for any of the table assemblies 100a-100c described herein. Furthermore, while the connections of the table extensions 160 are shown along one edge 103a (e.g., a long edge for wider tables relative to the vehicle 10 or a short edge for longer tables relative to the vehicle 10) of the table 102a-102c, the table extension 160 could alternatively or additionally be connected to one or more adjacent edges 103b (e.g., short edges for wider tables or long edges for longer tables) of the table 102a-102c. In another example, the table extension 160 could alternatively be coupled to the table 102a-102c to pivot to a side thereof rather than a front. Such an extension could be used on either or both lateral sides of the table 102a-102c to increase the width of the usable space in the use position.

Another example extension connection for the table 102a-102c described herein is shown in FIG. 15. In this example, the extension 160 is pivotably coupled to the table 102a-102c via edge face hinges 174, such that the hinges 174 are concealed between the table 102a-102c and extension 160 when the extension 160 is pivoted to the use position. The hinges 174 can be configured with recesses so that the table 102a-102c and extension 160 are substantially flush to one another in the use position.

Another example extension connection for the table 102a-102c is shown in FIG. 16. In this example, the extension 160 is slidingly coupled within a recess 176 defined in the table 102a-102c. The recess 176 can have an open bottom, as shown, or can be a cavity defined within the table 102a-102c. The extensions 160 can be configured to slide out forwardly, similar to that shown in FIGS. 11-13, and/or from one or both sides of the table 102c. The extension 160 of this example can include a catch mechanism (e.g., removable or biased pin, increased dimension(s) for a press fit in the use position, protrusion/cavity coupling, etc.) to hold the extension 160 in the use position or restrict movement of the extension 160 towards the storage position.

Table assemblies 100a-100c of the above examples can also be utilized in the recess 28 behind the bottom skirt portion 26 of the exterior 12. In these examples, the mount 110 is secured or otherwise coupled to a bottom surface of the floor 16, portions of the frame 14, outriggers from the frame 14, combinations thereof, and so forth. To maximize space, the mount 110 can be sized to extend to the frame 14.

All of the above example table assemblies 100a-100c can also include a door 170 configured to selectively cover the opening 24, such as when the table 102a-102c is in the storage position or when the table 102a-102c has been detached from the vehicle 10. The door 170 can be configured to be coplanar with the exterior 12 of the vehicle 10 when covering the opening 24. The door 170 can be pivotable about a hinge 172 extending along any desired side of the opening 24. The door 170 can be permanently coupled to the mount 110 or exterior 12, or can be removable. Alternatively, the door 170 can be affixed to a front edge of the table 102a-102c as an end cap, such that when the table 102a-102c is moved to the storage position, the door 170 covers the opening 24.

According to the examples described herein, a method for installing a table assembly (e.g., table assembly 100a-100b) includes coupling a sliding mechanism (e.g., sliding mechanism 104a-104c) to a mount (e.g., mount 110) within a recess (e.g., recess 22) defined in base structure, such as a floor, frame, and/or outriggers from the frame (e.g., floor 16, frame 14) of a vehicle (e.g., vehicle 10), where the table assembly including a table (e.g., table 102a-102c) coupled to the sliding mechanism to be movable relative to the vehicle.

In further examples, the method can include cutting an opening (e.g., opening 24) in an exterior (e.g., exterior 12) of the vehicle and installing the mount within the recess.

In further examples, installing the mount within the recess can include removing material (e.g., from structure 20) of a floor of the vehicle to create the recess or installing the mount beneath the floor (e.g., to the floor, the frame, and/or outriggers from the frame) aligned with the opening.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

The terms “substantially,” “approximately,” and “about” used throughout this Specification are used to describe and account for small fluctuations, such as due to variations in processing. For example, they can refer to less than or equal to +5%, such as less than or equal to +2%, such as less than or equal to +1%, such as less than or equal to +0.5%, such as less than or equal to +0.2%, such as less than or equal to +0.1%, such as less than or equal to +0.05%.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein

It will be appreciated that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. The same reference numbers may be used to describe like or similar parts. Further, while several examples have been disclosed herein, any features from any examples may be combined with or replaced by other features from other examples. Moreover, while several examples have been disclosed herein, changes may be made to the disclosed examples within departing from the scope of the claims.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A table assembly for a vehicle, the table assembly comprising:
a mount, the mount being of base structure of the vehicle or configured to be coupled to the vehicle within or adjacent to the base structure of the vehicle;
a table having an upper surface; and
a sliding mechanism coupled between the table and the mount, such that the table is movable between a storage position within an interior of the mount and a use position through an opening in an exterior of the vehicle.

2. The table assembly of claim 1, wherein the mount comprises side walls and a top wall extending between the side walls, the sliding mechanism coupled to the side walls.

3. The table assembly of claim 1, wherein the sliding mechanism comprises:
opposing rails having upper and lower walls defining a track therebetween; and
sliders coupled to lateral edges of the table and received between the upper and lower walls to slide within the track.

4. The table assembly of claim 1, wherein the sliding mechanism comprises a plurality of slide members nested together with bearings disposed therebetween.

5. The table assembly of claim 1, wherein the sliding mechanism comprises:
a bracket defining an elongate track opening; and
one or more posts coupled to lateral edges of the table and extending through the elongate track opening to slide therealong.

6. The table assembly of claim 1, further comprising one or more supports to hold the table in a horizontal orientation in the use position.

7. The table assembly of claim 6, wherein the one or more supports comprise the sliding mechanism.

8. The table assembly of claim 6, wherein the one or more supports comprise one or more tethers coupled to a front end portion of the table and configured to releasably couple to one of the mount or the vehicle.

9. The table assembly of claim 8, wherein the one or more tethers are rigid.

10. The table assembly of claim 6, wherein the one or more supports comprise brackets pivotably coupled to the table, the brackets configured to be pivoted to extend transverse to the table and releasably couple to one of the mount or the vehicle.

11. The table assembly of claim 1, further comprising one or more stops configured to selectively restrict movement of the table from the use position to the storage position.

12. The table assembly of claim 11, wherein the one or more stops comprise one or more rigid tethers coupled to the table and configured to releasably couple to one of the mount or the vehicle.

13. The table assembly of claim 11, wherein the one or more stops comprise brackets pivotably coupled to the table, the brackets configured to be pivoted to extend transverse to the table and releasably couple to one of the mount or the vehicle.

14. The table assembly of claim 1, further comprising a table extension pivotably coupled to the table, the table extension pivotable between a storage position extending across an upper surface of the table and a use position extending forwardly from the table.

15. The table assembly of claim 1, further comprising a door pivotably coupled to the mount to selectively cover the opening in the exterior of the vehicle.

16. The table assembly of claim 1 in combination with the vehicle, the base structure of the vehicle comprising a frame and a floor disposed above the frame, wherein the mount is installed within a recess defined in the floor of the vehicle between an upper surface of the floor and the frame.

17. The table assembly of claim 1 in combination with the vehicle, the base structure of the vehicle comprising a frame, a floor disposed above the frame, and a bottom skirt portion of the exterior extending downwardly relative to the floor, wherein the mount is installed within a recess defined between the frame and the bottom skirt portion.

18. A method comprising:
coupling a sliding mechanism of a table assembly to a mount within a recess defined in base structure of a vehicle, the table assembly comprising a table coupled to the sliding mechanism to be movable relative to the vehicle.

19. The method of claim 18, further comprising:
cutting an opening in an exterior of the vehicle; and
installing the mount within the recess.

20. The method of claim 19, wherein installing the mount within the recess comprises one of:
removing material of a floor of the vehicle to create the recess; or
installing the mount beneath the floor of the vehicle aligned with the opening.
